(19) United States
(12) Patent Application Publication
(10) Pub. No.: US 2025/0237434 A1
(43) Pub. Date: Jul. 24, 2025

(54) Method And System for Curing a Plant Material

(71) Applicant: Jon-Paul Bouttier, Mancos, CO (US)

(72) Inventor: Jon-Paul Bouttier, Mancos, CO (US)

(21) Appl. No.: 18/419,058

(22) Filed: Jan. 22, 2024

(51) Int. Cl. A01G 7/04; A01G 9/26

(52) U.S. Cl. CPC F26B 9/06; A23B 2/08; F26B 21/08

(57) ABSTRACT

A method for curing a plant material is disclosed. The method includes loading the plant material inside a dark chamber and maintaining a humidity level and a temperature inside the chamber at a first humidity level and a first temperature, respectively, for a first time duration. The first humidity level is between 65 percent and 85 percent and the first temperature is between 45 degrees Fahrenheit and 65 degrees Fahrenheit. The method further includes changing the humidity level and the temperature inside the chamber from the first humidity level and the first temperature to a second humidity level and a second temperature, respectively, upon elapse of the first time duration. The second humidity level is between 45 percent and 65 percent and the second temperature is between 65 degrees Fahrenheit and 85 degrees Fahrenheit.

### TECHNICAL FIELD

The present disclosure relates, generally, a method for curing a plant material, and more particularly to a method and system for curing a plant material using controlled environmental conditions.

### BACKGROUND

Cannabis plant material is generally cured after harvesting to facilitate effective consumption of the cannabis. Curing of the cannabis plant material is essential to fine-tune the moisture content present inside the cannabis and to allow decay of sugars and chlorophyll before consumption. Conventionally, the curing is performed in a dark room by maintaining an ideal temperature and humidity level inside the dark room. However, the conventional curing methods are not very effective and reduces the overall oil content in the cured material.

### SUMMARY

One aspect of this disclosure relates to a method for curing a plant material. The method includes loading the plant material inside a dark chamber and maintaining a humidity level and a temperature inside the chamber at a first humidity level and a first temperature, respectively, for a first time duration. The first humidity level is between 65 percent and 85 percent and the first temperature is between 45 degrees Fahrenheit and 65 degrees Fahrenheit. The method further includes changing the humidity level and the temperature inside the chamber from the first humidity level and the first temperature to a second humidity level and a second temperature, respectively, upon elapse of the first time duration. The second humidity level is between 45 percent and 65 percent and the second temperature is between 65 degrees Fahrenheit and 85 degrees Fahrenheit.

In some additional, alternative, or selectively cumulative embodiments, the method further includes maintaining the humidity level and the temperature inside the chamber at the second humidity level and the second temperature, respectively, for a second time duration.

In some additional, alternative, or selectively cumulative embodiments, the second time duration is about 5 days.

In some additional, alternative, or selectively cumulative embodiments, the first humidity level is between 70 percent and 80 percent.

In some additional, alternative, or selectively cumulative embodiments, the first temperature is between 50 degrees Fahrenheit and 60 degrees Fahrenheit.

In some additional, alternative, or selectively cumulative embodiments, the second humidity level is between 50 percent and 60 percent.

In some additional, alternative, or selectively cumulative embodiments, the second temperature is between 70 degrees Fahrenheit and 80 degrees Fahrenheit.

In some additional, alternative, or selectively cumulative embodiments, the first humidity level is about 75 percent.

In some additional, alternative, or selectively cumulative embodiments, the first temperature is about 55 degrees Fahrenheit.

In some additional, alternative, or selectively cumulative embodiments, the second humidity level is about 55 percent.

In some additional, alternative, or selectively cumulative embodiments, the second temperature is about 75 degrees Fahrenheit.

In some additional, alternative, or selectively cumulative embodiments, the first time duration is about 5 days.

One aspect of the disclosure relates to a system for curing a plant material inside a chamber. The system includes a humidifier configured to control a humidity level inside the chamber, a temperature control device configured to control a temperature inside the chamber, and a controller arranged in communication with the humidifier and the temperature control device. The controller is configured to control the humidifier and the temperature control device to maintain the humidity level and the temperature inside the chamber at a first humidity level and a first temperature for a first time duration. The first humidity level is between 65 percent and 85 percent and first temperature is between 45 degrees Fahrenheit and 65 degrees Fahrenheit. The controller is further configured to control the humidifier and the temperature control device to change the humidity level and the temperature inside the chamber from the first humidity level and the first temperature to a second humidity level and a second temperature, respectively, upon elapse of the first time duration. The second humidity level is between 45 percent and 65 percent and the second temperature is between 65 degrees Fahrenheit and 85 degrees Fahrenheit.

In some additional, alternative, or selectively cumulative embodiments, the system further includes at least one temperature sensor configured to measure the temperature inside the chamber and at least one humidity sensor configured to determine a humidity level inside the chamber. The controller is configured to control the humidifier and the temperature control device based on input from the at least one temperature sensor and the at least one humidity sensor.

In some additional, alternative, or selectively cumulative embodiments, the controller is configured to control the humidifier and the temperature control device to maintain the humidity level and the temperature inside the chamber at the second humidity level and the second temperature, respectively, for a second time duration.

In some additional, alternative, or selectively cumulative embodiments, the first humidity level is between 70 percent and 80 percent and the first temperature is between 50 degrees Fahrenheit and 60 degrees Fahrenheit.

In some additional, alternative, or selectively cumulative embodiments, the second humidity level is between 50 percent and 60 percent and the second temperature is between 70 degrees Fahrenheit and 80 degrees Fahrenheit.

In some additional, alternative, or selectively cumulative embodiments, the first humidity level is about 75 percent and the first temperature is about 55 degrees Fahrenheit.

In some additional, alternative, or selectively cumulative embodiments, the second humidity level is about 55 percent and the second temperature is about 75 degrees Fahrenheit.

In some additional, alternative, or selectively cumulative embodiments, the first time duration is about 5 days.

### BRIEF DESCRIPTION OF THE ACCOMPANYING DRAWINGS

Having thus described example embodiments of the present disclosure in general terms, reference will now be made to the accompanying drawings, which are not necessarily drawn to scale, and wherein:

FIG. 1 illustrates a method for curing a plant material inside a chamber, in accordance with an embodiment of the disclosure; and

FIG. 2 illustrates a schematic block diagram of a system for performing the method of FIG. 1, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. The use of any term should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

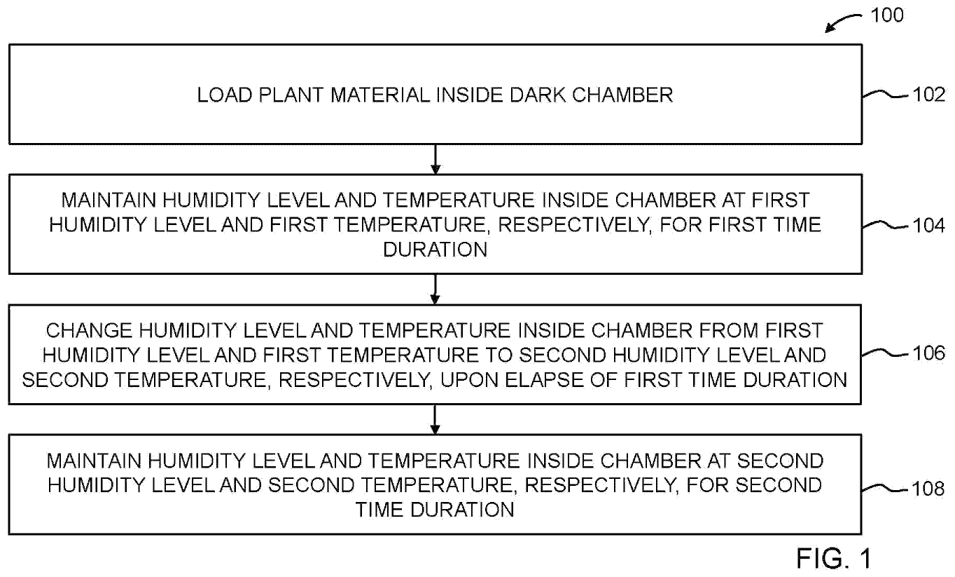

Referring to FIG. 1, a method 100 for curing a plant material such as hemp or cannabis is disclosed. Although the method 100 is described for curing the cannabis plant material, it may be envisioned that the method 100 may be used to cure any other similar plant material, such as, but not limited, to lavender or tobacco. The method 100 includes a step 102 at which the plant material is arranged inside a chamber, for example, a room. Also, the chamber is a dark room that lacks light and prevents entry of sunlight. The darkness or the lack of sunlight in the chamber reduces/slows the plant's metabolism. Further, the method 100 includes controlling one or more environmental parameters inside the chamber to facilitate a curing of the plant material. For example, the method 100 includes a step 104 after the step 102 at which a humidity level and a temperature inside the chamber are set and maintained at a first humidity level and a first temperature. In an embodiment, the first humidity level is between 65 percent and 85 percent. In some embodiments, the first humidity level is between 70 percent and 80 percent. In some embodiments, the first humidity level is about 75 percent. In an embodiment, the first temperature is between 45 degrees Fahrenheit and 65 degrees Fahrenheit. In some embodiments, the first temperature lies between 50 degrees Fahrenheit and 60 degrees Fahrenheit. In some scenarios, the first temperature is about 55 degrees Fahrenheit. High humidity keeps the plant alive longer by slowing down the drying process. Also, maintaining the high humidity level at lower temperature facilitates in protecting the trichrome present in the plant material from oxidation during curing as enzymes driving biochemical reactions don't function well below certain temperature, for example, sixty degrees Fahrenheit. It may be appreciated that the humidity level and the temperature are maintained at the first humidity level and the first temperature, respectively, for a first time duration. In some embodiments, the first time duration is 4-6 days. In a scenario, the first time duration is 5 days.

Upon elapse of the first time duration, the method 100 moves to a step 106 at which the humidity level and the temperature inside the chamber are changed and flipped to a second humidity level and a second temperature. In an embodiment, the second humidity level lies between 45 percent and 65 percent. In some embodiments, the second humidity level lies between 50 percent and 60 percent. In some scenarios, the second humidity level is about 55 percent. In an embodiment, the second temperature is between 65 degrees Fahrenheit and 85 degrees Fahrenheit. In some embodiments, the second temperature is between 70 degrees Fahrenheit and 80 degrees Fahrenheit. In a scenario, the second temperature is about 75 degrees Fahrenheit.

The method 100 also includes a step 108 after the step 106 at which the humidity level and the temperature inside the chamber are maintained at the second humidity level and the second temperature for a second time duration. Maintaining the second humidity level and the second temperature inside the room facilitates a drying of the plant material stored inside the chamber. In some embodiments, the second time duration is between 4 days to 6 days. In an embodiment, the second time duration is 5 days. Flipping/changing the environmental conditions inside the chamber to a higher temperature (i.e., the second temperature) and a lower humidity level (i.e., second humidity level) causes rapid drying and curing to take place, locking-up the monolayer. Achieving both unique conditions to keep microbial activity to a minimum.

In this manner, the method 100 facilitates production of a superior quality cured product under two weeks with ideal water activity and moisture content, maintaining ten percent or more essential oils compared to industry standard. Also, the method 100 enables holding ideal water activity and moisture content inside the plant material, thereby preserving aroma composition.

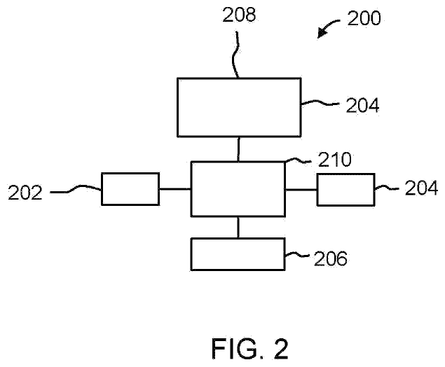

Referring to FIG. 2, a system 200 to perform the method 100 is shown. The system 200 includes a humidifier 202 to control the humidity level inside the chamber at any desired humidity level, for example, the first humidity level and the second humidity level. The humidifier 202 is arranged to increase and/or decrease the humidity level inside the chamber to achieve the desired humidity level. In an embodiment, the humidifier 202 may include a spray mist device to spray mist of water inside the chamber to increase the humidity level within the chamber. However, any other suitable humidifier to increase or decrease the humidity level inside the chamber, such as, condensing coil, pan humidifier, air washer may also be used. In some embodiments, the humidifier 202 may also include a moisture extractor configured to decrease humidity by extracting/removing moisture from air inside the chamber.

Further, the system 200 includes a temperature control device 204 to control and maintain any predetermined/desired temperature, for example, the first temperature and the second temperature, inside the chamber. In some embodiments, the temperature control device 204 may include a suitable heater and/or cooler known in the art to increase and/or decrease the temperature inside the chamber to maintain the temperature inside the chamber at any desired level.

Also, the system 200 includes at least one humidity sensor 206 to measure the humidity level inside the chamber and at least one temperature sensor 208 to measure/determine the temperature inside the chamber. Further, the system 200 includes a controller 210 arranged in communication with the at least one humidity sensor 206, at least one temperature senor 208, the humidifier 202, and the temperature control device 204 and configured to control the humidifier 202 and the temperature control device 204 based on the input received from the at least one humidity sensor 206 and the at least one temperature sensor 208 to control and maintain the temperature and humidity level inside the chamber to any desired values. It may be appreciated that the desired temperature and humidity level may be pre-stored inside the controller 210 and the time duration associated with the desired temperature level and the humidity level. For example, upon loading of the plant material inside the chamber, the controller 210 initiate the curing process of the plant material. For so doing, the controller 210 determines the temperature and the humidity level inside the chamber based on the inputs from the sensor 206, 208 and controls the humidifier 202 and the temperature control device 204 to increase or decrease the humidity level and the temperature to achieve and maintain the humidity level and the temperature inside the chamber at the first humidity level and the first temperature. Further, the controller 210 is configured to maintain the humidity level and the temperature inside the chamber at the first humidity level and the first temperature for a first time period. Further, the controller 210 determines a time duration that has elapsed since setting up the temperature and humidity level inside the chamber to the first temperature and first humidity level.

Upon elapse of the first-time duration, the controller 210 controls the humidifier 202 and the temperature control device 204 to adjust the temperature and the humidity level to the second temperature and the second humidity level and maintains the temperature and the humidity level at the second temperature and the second humidity level for a second time duration based on input received from the sensors 206, 208. Upon elapse of the second time duration, the controller 210 may generate an alert to notify a user about a completion of the curing process. For so doing, the system 200 may include an alarm that may be audio alarm and/or visual alarm. In some embodiments, the controller 210 may shut down the system 200 i.e., the humidifier 202 and the temperature control device 204 upon elapse of the second time duration.

In some embodiments, the system 200 may include a user interface to switch on and switch off the system 200 and may also facilitate to input one or more desired temperatures and desired humidity levels and associated one or more time duration, and the sequence in which the one or more desired temperatures and the one or more humidity levels need to be maintained inside the chamber.

In an additional embodiment, following the method described above, the plant material is removed from the first chamber and placed in a second, finishing chamber. The plant material then remains in the finishing chamber for a predetermined duration of time. During the predetermined duration, the finishing chamber is opened at predetermined intervals for predetermined periods of time for the duration of time the plant material is in the second chamber. The intervals may be consistent, or they may be changing over the duration of time the plant material is in the second chamber. For illustrative purposes only, in one embodiment, the plant material is removed from the curing chamber and placed into the finishing chamber for a period of 24 hrs. After one hour in the finishing chamber, the chamber is opened for a period of five minutes and then closed again for a period of 55 minutes. This process is repeated for the total 24-hour duration. The finishing chamber may be opened manually or an automatic system may be arranged to open and close the chamber as needed.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for curing a plant material (cannabis), the method comprising:
loading the plant material inside a dark chamber;
maintaining a humidity level and a temperature inside the chamber at a first humidity level and a first temperature, respectively, for a first time duration, wherein the first humidity level is between 65 percent and 85 percent and the first temperature is between 45 degrees Fahrenheit and 65 degrees Fahrenheit; and
changing the humidity level and the temperature inside the chamber from the first humidity level and the first temperature to a second humidity level and a second temperature, respectively, upon elapse of the first time duration, wherein the second humidity level is between 45 percent and 65 percent and the second temperature is between 65 degrees Fahrenheit and 85 degrees Fahrenheit.

2. The method of claim 1 further including maintaining the humidity level and the temperature inside the chamber at the second humidity level and the second temperature, respectively, for a second time duration.

3. The method of claim 2, wherein the second time duration is about 5 days.

4. The method of claim 1, wherein the first humidity level is between 70 percent and 80 percent.

5. The method of claim 1, wherein the first temperature is between 50 degrees Fahrenheit and 60 degrees Fahrenheit.

6. The method of claim 1, wherein the second humidity level is between 50 percent and 60 percent.

7. The method of claim 1, wherein the second temperature is between 70 degrees Fahrenheit and 80 degrees Fahrenheit.

8. The method of claim 1, wherein the first humidity level is about 75 percent.

9. The method of claim 1, wherein the first temperature is about 55 degrees Fahrenheit.

10. The method of claim 1, wherein the second humidity level is about 55 percent.

11. The method of claim 1, wherein the second temperature is about 75 degrees Fahrenheit.

12. The method of claim 1, wherein the first time duration is about 5 days.

13. A system for curing a plant material inside a chamber, the system comprising:
a humidifier configured to control a humidity level inside the chamber,
a temperature control device configured to control a temperature inside the chamber; and
a controller arranged in communication with the humidifier and the temperature control device and configured to control the humidifier and the temperature control device to maintain the humidity level and the temperature inside the chamber at a first humidity level and a first temperature for a first time duration, wherein the first humidity level is between 65 percent and 85 percent and first temperature is between 45 degrees Fahrenheit and 65 degrees Fahrenheit, and
control the humidifier and the temperature control device to change the humidity level and the temperature inside the chamber from the first humidity level and the first temperature to a second humidity level and a second temperature, respectively, upon elapse of the first time duration, wherein the second humidity level is between 45 percent and 65 percent and the second temperature is between 65 degrees Fahrenheit and 85 degrees Fahrenheit.

14. The system of claim 13 further including
at least one temperature sensor configured to measure the temperature inside the chamber, and
at least one humidity sensor configured to determine a humidity level inside the chamber, wherein
the controller is configured to control the humidifier and the temperature control device based on input from the at least one temperature sensor and the at least one humidity sensor.

15. The system of claim 13, wherein the controller is configured to control the humidifier and the temperature control device to maintain the humidity level and the temperature inside the chamber at the second humidity level and the second temperature, respectively, for a second time duration.

16. The system of claim 13, wherein
the first humidity level is between 70 percent and 80 percent, and
the first temperature is between 50 degrees Fahrenheit and 60 degrees Fahrenheit.

17. The system of claim 13, wherein
the second humidity level is between 50 percent and 60 percent, and
the second temperature is between 70 degrees Fahrenheit and 80 degrees Fahrenheit.

18. The system of claim 13, wherein
the first humidity level is about 75 percent, and
the first temperature is about 55 degrees Fahrenheit.

19. The system of claim 13, wherein
the second humidity level is about 55 percent, and
the second temperature is about 75 degrees Fahrenheit.

20. The system of claim 13, wherein the first time duration is about 5 days.
